(19) United States
(12) Patent Application Publication
(10) Pub. No.: US 2021/0056708 A1
(43) Pub. Date: Feb. 25, 2021

(54) TARGET DETECTION AND TRAINING FOR TARGET DETECTION NETWORK

(71) Applicant: BEIJING SENSETIME TECHNOLOGY DEVELOPMENT CO., LTD., Beijing (CN)

(72) Inventor: Cong LI, Beijing (CN)

(21) Appl. No.: 17/076,136

(22) Filed: Oct. 21, 2020

Related U.S. Application Data
(63) Continuation of application No. PCT/CN2019/128383, filed on Dec. 25, 2019.

(30) Foreign Application Priority Data
Jun. 26, 2019 (CN) 201910563005.8

(51) Int. Cl. G06T 7/194; G06T 7/187; G06N 3/08

(52) U.S. Cl. CPC G06T 7/194; G06T 2210/12; G06N 3/08; G06T 7/187

(57) ABSTRACT

A method, apparatus and device for target detection, as well as a training method, apparatus and device for target detection network are disclosed. The method for target detection includes that: feature data of an input image is obtained; multiple candidate bounding boxes of the input image are determined according to the feature data; a foreground segmentation result of the input image is obtained according to the feature data, the foreground segmentation result including indication information for indicating whether each of the input image belongs to a foreground; and a target detection result of the input image is obtained according to the multiple candidate bounding boxes and the foreground segmentation result.

### CROSS-REFERENCE TO RELATED APPLICATION

This is a continuation application of International Patent Application No. PCT/CN2019/128383, filed on Dec. 25, 2019, which claims priority to Chinese Patent Application No. 201910563005.8, filed on Jun. 26, 2019. The contents of International Patent Application No. PCT/CN2019/128383 and Chinese Patent Application No. 201910563005.8 are incorporated herein by reference in their entireties.

### BACKGROUND

Target detection is an important issue in the field of computer vision. Particularly for detection on military targets such as airplanes and vessels, due to the features of large image size and small target size, the detection is very tough. Moreover, for targets having a closely arranged state such as the vessels, the detection accuracy is relatively low.

### SUMMARY

The disclosure relates to the technical field of image processing, and in particular to a method, apparatus and device for target detection, as well as a training method, apparatus and device for target detection network.

Embodiments of the disclosure provide a method, apparatus and device for target detection, as well as a training method, apparatus and device for target detection network.

A first aspect provides a method for target detection, which includes the following operations.

Feature data of an input image is obtained; multiple candidate bounding boxes of the input image are determined according to the feature data; a foreground segmentation result of the input image is obtained according to the feature data, the foreground segmentation result including indication information for indicating whether each of multiple pixels of the input image belongs to a foreground; and a target detection result of the input image is obtained according to the multiple candidate bounding boxes and the foreground segmentation result.

A second aspect provides a training method for a target detection network. The target detection network includes a feature extraction network, a target prediction network and a foreground segmentation network, and the method includes the following operations.

Feature extraction processing is performed on a sample image through the feature extraction network to obtain feature data of the sample image; multiple sample candidate bounding boxes are obtained through the target prediction network according to the feature data; a sample foreground segmentation result of the sample image is obtained through the foreground segmentation network according to the feature data, the sample foreground segmentation result including indication information for indicating whether each of multiple pixels of the sample image belongs to a foreground; a network loss value is determined according to the multiple sample candidate bounding boxes, the sample foreground segmentation result and labeling information of the sample image; and a network parameter of the target detection network is adjusted based on the network loss value.

A third aspect provides an apparatus for target detection, which includes: a feature extraction unit, a target prediction unit, a foreground segmentation unit and a target determination unit.

The feature extraction unit is configured to obtain feature data of an input image; the target prediction unit is configured to determine multiple candidate bounding boxes of the input image according to the feature data; the foreground segmentation unit is configured to obtain a foreground segmentation result of the input image according to the feature data, the foreground segmentation result including indication information for indicating whether each of multiple pixels of the input image belongs to a foreground; and the target determination unit is configured to obtain a target detection result of the input image according to the multiple candidate bounding boxes and the foreground segmentation result.

A fourth aspect provides a training apparatus for a target detection network. The target detection network includes a feature extraction network, a target prediction network and a foreground segmentation network, and the apparatus includes: a feature extraction unit, a target prediction unit, a foreground segmentation unit, a loss value determination unit and a parameter adjustment unit.

The feature extraction unit is configured to perform feature extraction processing on a sample image through the feature extraction network to obtain feature data of the sample image; the target prediction unit is configured to obtain multiple sample candidate bounding boxes through the target prediction network according to the feature data; the foreground segmentation unit is configured to obtain a sample foreground segmentation result of the sample image through the foreground segmentation network according to the feature data, the sample foreground segmentation result including indication information for indicating whether each of multiple pixels of the sample image belongs to a foreground; the loss value determination unit is configured to determine a network loss value according to the multiple sample candidate bounding boxes and the sample foreground segmentation result as well as labeling information of the sample image; and the parameter adjustment unit is configured to adjust a network parameter of the target detection network based on the network loss value.

A fifth aspect provides a device for target detection, which includes a memory and a processor; the memory is configured to store computer instructions capable of running on the processor; and the processor is configured to execute the computer instructions to implement the above method for target detection.

A sixth aspect provides a target detection network training device, which includes a memory and a processor; the memory is configured to store computer instructions capable of running on the processor; and the processor is configured to execute the computer instructions to implement the above target detection network training method.

A seventh aspect provides a non-volatile computer-readable storage medium, which stores computer programs thereon; and the computer programs are executed by a processor to cause the processor to implement the above method for target detection, and/or, to implement the above training method for a target detection network.

It is to be understood that the above general descriptions and detailed descriptions below are only exemplary and explanatory and not intended to limit the present disclosure.

### BRIEF DESCRIPTION OF THE DRAWINGS

The accompanying drawings, which are incorporated in and constitute a part of the specification, illustrate embodiments consistent with the disclosure and, together with the description, serve to explain the principles of the disclosure.

FIG. 1 is a flowchart of a method for target detection according to embodiments of the disclosure.

FIG. 2 is a schematic diagram of a method for target detection according to embodiments of the disclosure.

FIG. 3A and FIG. 3B respectively are a diagram of a vessel detection result according to embodiments of the disclosure.

FIG. 4 is a schematic diagram of a target bounding box in the relevant art.

FIG. 5A and FIG. 5B respectively are a schematic diagram of a method for calculating an overlapping parameter according to exemplary embodiments of the disclosure.

FIG. 6 is a flowchart of a training method for target detection network according to embodiments of the disclosure.

FIG. 7 is a schematic diagram of a method for calculating an IoU according to embodiments of the disclosure.

FIG. 8 is a network structural diagram of a target detection network according to embodiments of the disclosure.

FIG. 9 is a schematic diagram of a training method for target detection network according to embodiments of the disclosure.

FIG. 10 is a flowchart of a method for predicting a candidate bounding box according to embodiments of the disclosure.

FIG. 11 is a schematic diagram of an anchor box according to embodiments of the disclosure.

FIG. 12 is a flowchart of a method for predicting a foreground image region according to exemplary embodiments of the disclosure.

FIG. 13 is a structural schematic diagram of an apparatus for target detection according to exemplary embodiments of the disclosure.

FIG. 14 is a structural schematic diagram of a training apparatus for target detection network according to exemplary embodiments of the disclosure.

FIG. 15 is a structural diagram of a device for target detection according to exemplary embodiments of the disclosure.

FIG. 16 is a structural diagram of a training device for target detection network according to exemplary embodiments of the disclosure.

### DETAILED DESCRIPTION

According to the method for target detection, an apparatus and a device as well as a training method for target detection networks, an apparatus and a device provided by one or more embodiments of the disclosure, the multiple candidate bounding boxes are determined according to the feature data of the input image, and the foreground segmentation result is obtained according to the feature data; and in combination with the multiple candidate bounding box and the foreground segmentation result, the detected target object can be determined more accurately.

Reference will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of exemplary embodiments do not represent all implementations consistent with the present disclosure. Instead, they are merely examples of apparatuses and methods consistent with aspects related to the present disclosure as recited in the appended claims.

It is to be understood that the technical solutions provided in the embodiments of the disclosure are mainly applied to detecting an elongated small target in an image but is not limited thereto in the embodiments of the disclosure.

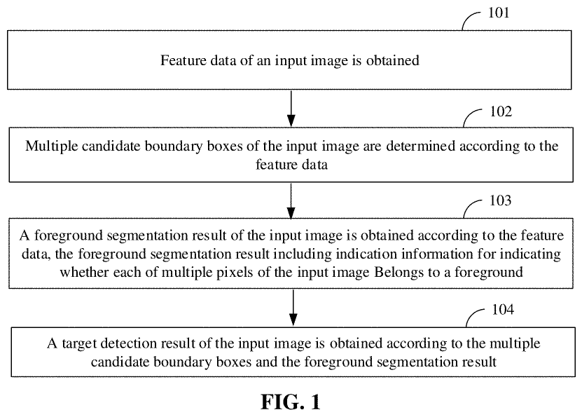

FIG. 1 illustrates a method for target detection. The method may include the following operations.

In 101, feature data (such as a feature map) of an input image is obtained.

In some embodiments, the input image may be a remote sensing image. The remote sensing image may be an image obtained through a ground-object electromagnetic radiation characteristic signal and the like that is detected by a sensor carried on an artificial satellite and an aerial plane. It is to be understood by those skilled in the art that the input image may also be other types of images and is not limited to the remote sensing image.

In an example, the feature data of the sample image may be extracted through a feature extraction network such as a convolutional neural network. The specific structure of the feature extraction network is not limited in the embodiments of the disclosure. The extracted feature data is multi-channel feature data. The size and the number of channels of the feature data are determined by the specific structure of the feature extraction network.

In another example, the feature data of the input image may be obtained from other devices, for example, feature data sent by a terminal is received, which is not limited thereto in the embodiments of the disclosure.

In 102, multiple candidate bounding boxes of the input image are determined according to the feature data.

In this operation, the candidate bounding box is obtained by predicting with, for example, a region of interest (ROI) technology and the like. The operation includes obtaining parameter information of the candidate bounding box, and the parameter may include one or any combination of a length, a width, a coordinate of a central point, an angle and the like of the candidate bounding box.

In 103, a foreground segmentation result of the input image is obtained according to the feature data, the foreground segmentation result including indication information for indicating whether each of multiple pixels of the input image belongs to a foreground.

The foreground segmentation result, obtained based on the feature data, includes a probability that each pixel, in multiple pixels of the input image, belongs to the foreground and/or the background. The foreground segmentation result provides a pixel-level prediction result.

In 104, a target detection result of the input image is obtained according to the multiple candidate bounding boxes and the foreground segmentation result.

In some embodiments, the multiple candidate bounding boxes determined according to the feature data of the input image and the foreground segmentation result obtained through the feature data have a corresponding relationship. By mapping the multiple candidate bounding boxes to the foreground segmentation result, the candidate bounding box having better fitting with an outline of the target object is closer to overlap with the foreground image region corresponding to the foreground segmentation result. Therefore, in combination with the determined multiple candidate bounding boxes and the obtained foreground segmentation result, the detected target object may be determined more accurately. In some embodiments, the target detection result may include a position, the number and other information of the target object included in the input image.

In an example, at least one target bounding box may be selected from the multiple candidate bounding boxes according to an overlapping area between each candidate bounding box in the multiple candidate bounding boxes and a foreground image region corresponding to the foreground segmentation result; and the target detection result of the input image is obtained based on the at least one target bounding box.

In the multiple candidate bounding boxes, the larger the overlapping area with the foreground image region, the closer the overlapping between the candidate bounding box and the foreground image region, which indicates that the fitting between the candidate bounding box and the outline of the target object is better, and also indicates that the prediction result of the candidate bounding box is more accurate. Therefore, according to the overlapping area between the candidate bounding box and the foreground image, at least one candidate bounding box may be selected from the multiple candidate bounding boxes to serve as a target bounding box, and the selected target bounding box is taken as the detected target object to obtain the target detection result of the input image.

For example, a candidate bounding box having a proportion occupied by the overlapping area with the foreground image region in the whole candidate bounding box greater than the first threshold in the multiple candidate bounding boxes may be taken as the target bounding box. The larger the proportion occupied by the overlapping area in the whole candidate bounding box, the higher the degree of overlapping between the candidate bounding box and the foreground image region. It is to be understood by those skilled in the art that the specific value of the first threshold is not limited in the disclosure, and may be determined according to an actual demand.

The method for target detection in the embodiments of the disclosure may be applied to a to-be-detected target object having an excessive length-width ratio, such as an airplane, a vessel, a vehicle and other military objects. In an example, the excessive length-width ratio refers to that the length-width ratio is greater than a specific value, for example, the length-width ratio is greater than 5. It is to be understood by those skilled in the art that the specific value may be specifically determined according to the detected object. In an example, the target object may be the vessel.

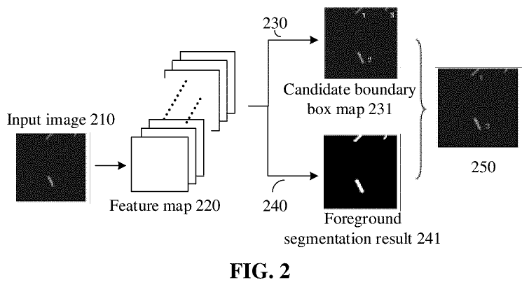

Hereinafter, the case where the input image is the remote sensing image and the detection target is the vessel is used as an example to describe the target detection process. It is to be understood by those skilled in the art that the method for target detection may also be used for other target objects. FIG. 2 illustrates the schematic diagram of the method for target detection.

Firstly, multi-channel feature data (i.e., the feature map 220 in FIG. 2) of the remote sensing image (i.e., the input image 210 in FIG. 2) is obtained.

The above feature data is respectively input to a first branch (the upper branch 230 in FIG. 2) and a second branch (the lower branch 240 in FIG. 2) and subjected to the following processing.

Concerning the First Branch

A confidence score is generated for each anchor box. The confidence score is associated with the probability of the inside of the anchor box being the foreground or the background, for example, the higher the probability of the anchor box being the foreground is, the higher the confidence score is.

In some embodiments, the anchor box is a rectangular box based on priori knowledge. The specific implementation method of the anchor box may refer to the subsequent description on training of the target detection network, and is not detailed herein. The anchor box may be taken as a whole for prediction, so as to calculate the probability of the inside of the anchor box being the foreground or the background, i.e., whether an object or a special target is included in the anchor box is predicted. If the anchor box includes the object or the special target, the anchor box is determined as the foreground.

In some embodiments, according to confidence scores, at least one anchor box of which the confidence score is the highest or exceed a certain threshold may be selected as the foreground anchor box; by predicting an offset of the foreground anchor box to the candidate bounding box, the foreground anchor box may be shifted to obtain the candidate bounding box; and based on the offset, the parameter of the candidate bounding box may be obtained.

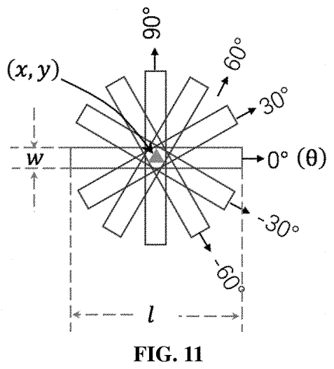

In an example, the anchor box may include direction information, and may be provided with multiple length-width ratios to cover the to-be-detected target object. The specific number of directions and the specific value of the length-width ratio may be set according to an actual demand. As shown in FIG. 11, the constructed anchor box corresponds to six directions, where the w denotes a width of the anchor box, the 1 denotes a length of the anchor box, the θ denotes an angle of the anchor box (a rotation angle of the anchor box relative to a horizontal direction), and the (x,y) denotes a coordinate of a central point of the anchor box. For six anchor boxes uniformly distributed in the direction, the values of θ may be 0°, 30°, 60°, 90°, −30° and −60°, respectively.

In an example, after the one or more candidate bounding boxes are generated, one or more overlapped detection boxes may further be removed by Non-Maximum Suppression (NMS). For example, all candidate bounding boxes may be first traversed; the candidate bounding box having the highest confidence score is selected; the rest candidate bounding boxes are traversed; and if a bounding box of which the IoU with the bounding box currently having the highest score is greater than a certain threshold, the bounding box is removed. Thereafter, the candidate bounding box having the highest score is continuously selected from the unprocessed candidate bounding boxes, and the above process is repeated. With multiple times of iterations, the one or more unsuppressed candidate bounding boxes are kept finally to serve as the determined candidate bounding boxes. With FIG. 2 as an example, through the NMS processing, three candidate bounding boxes labeled as 1, 2, and 3 in the candidate bounding box map 231 are obtained.

Concerning the Second Branch

According to the feature data, for each pixel in the input image, a probability of the each pixel being the foreground or the background is predicted, and by taking the pixel of which the probability being the foreground is higher than the set value as the foreground pixel, a pixel-level foreground segmentation result 241 is generated.

As the results output by the first branch and the second branch are consistent in size, the one or more candidate bounding boxes may be mapped to the pixel segmentation result, and the target bounding box is determined according to the overlapping area between the one or more candidate bounding boxes and the foreground image region corresponding to the foreground segmentation result. For example, the candidate bounding box having a proportion occupied by the overlapping area in the whole candidate bounding box greater than the first threshold may be taken as the target bounding box.

With FIG. 2 as an example, by mapping three candidate bounding boxes labeled as 1, 2 and 3 respectively to the foreground segmentation result, the proportion, occupied by the overlapping area between each candidate bounding box and the foreground image region, in the whole candidate bounding box may be calculated. For instance, the proportion for the candidate bounding box 1 is 92%, the proportion for the candidate bounding box 2 is 86%, and the proportion for the candidate bounding box 3 is 65%. In a case where the first threshold is 70%, the probability of the candidate bounding box 3 being the target bounding box is excluded; and in the finally detected output result diagram 250, the target bounding box is the candidate bounding box 1 and the candidate bounding box 2.

By detecting with the above method, the output target bounding boxes still have a probability that they are overlapped. For example, during NMS processing, if an excessively high threshold is set, it is possible that the overlapped candidate bounding boxes are not suppressed. In a case where the proportion, occupied by the overlapping area between the candidate bounding box and the foreground image region, in the whole candidate bounding box exceeds the first threshold, the finally output target bounding boxes may still include the overlapped bounding boxes.

In a case where the selected at least one target bounding box includes a first bounding box and a second bounding box, the final target object may be determined by the following method in the embodiments of the disclosure. It is to be understood by those skilled in the art that the method is not limited to process two overlapped bounding boxes, and may also process multiple overlapped bounding boxes in a method of processing two bounding boxes firstly and then processing one kept bounding box and other bounding boxes.

In some embodiments, an overlapping parameter between the first bounding box and the second bounding box is determined based on an angle between the first bounding box and the second bounding box; and target object position(s) corresponding to the first bounding box and the second bounding box is/are determined based on the overlapping parameter of the first bounding box and the second bounding box.

In a case where two to-be-detected target objects are closely arranged, it is possible that target bounding boxes (the first bounding box and the second bounding box) of the two to-be-detected target objects are repeated. However, in such a case, the first bounding box and the second bounding box often have a relatively small IoU. Therefore, whether detection objects in the two bounding boxes are the target objects are determined by setting the overlapping parameter between the first bounding box and the second bounding box in the disclosure.

In some embodiments, in a case where the overlapping parameter is greater than a second threshold, it is indicated that the first bounding box and the second bounding box may include only a same target object, and one bounding box therein is taken as the target object position. Since the foreground segmentation result includes the pixel-level foreground image region, which bounding box is kept and taken as the bounding box of the target object may be determined by use of the foreground image region. For example, the first overlapping parameter between the first bounding box and the corresponding foreground image region and the second overlapping parameter between the second bounding box and the corresponding foreground image region may be respectively calculated, the target bounding box corresponding to a larger value in the first overlapping parameter and the second overlapping parameter is determined as the target object, and the target bounding box corresponding to a smaller value is removed. By means of the above method, one or more bounding boxes that are overlapped on one target object are removed.

In some embodiments, in a case where the overlapping parameter is smaller than or equal to the second threshold, each of the first bounding box and the second bounding box are taken as a target object position.

The process for determining the final target object is described below exemplarily.

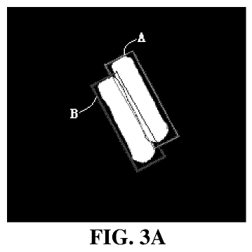

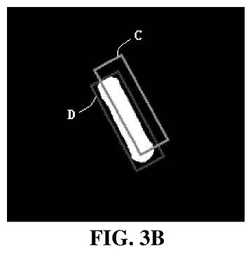

In an embodiment, as shown in FIG. 3A, the bounding boxes A and B are vessel detection result. The bounding box A and the bounding box B are overlapped, and the overlapping parameter between the bounding box A and the bounding box B is calculated as 0.1. In a case where the second threshold is 0.3, it is determined that the bounding box A and the bounding box B are detection results of two different vessels. By mapping the bounding boxes to the pixel segmentation result, it can be seen that the bounding box A and the bounding box B respectively correspond to different vessels. In a case where the overlapping parameter between the two bounding boxes is smaller than the second threshold, it is unnecessary to additionally map the bounding boxes to the pixel segmentation result. The above mapping is merely for verification.

In another embodiment, as shown in FIG. 3B, the bounding boxes C and D are another vessel detection result. The bounding box C and the bounding box D are overlapped, and the overlapping parameter between the bounding box C and the bounding box D is calculated as 0.8, i.e., greater than the second threshold 0.3. Based on the calculated overlapping parameter result, it may be determined that the bounding box C and the bounding box D are bounding boxes of the same vessel. In such a case, by mapping the bounding box C and the bounding box D to the pixel segmentation result, the final target object is further determined by using the corresponding foreground image region. The first overlapping parameter between the bounding box C and the foreground image region as well as the second overlapping parameter between the bounding box D and the foreground image region are calculated. For example, the first overlapping parameter is 0.9 and the second overlapping parameter is 0.8. It is determined that the bounding box C corresponding to the first overlapping parameter having the larger value includes the vessel. At the meantime, the bounding box D corresponding to the second overlapping parameter is removed. Finally, the bounding box C is output to be taken as the target bounding box of the vessel.

In some embodiments, the target object of the overlapped bounding boxes is determined with the assistance of the foreground image region corresponding to the pixel segmentation result. As the pixel segmentation result corresponds to the pixel-level foreground image region and the spatial accuracy is high, the target bounding box including the target object is further determined through the overlapping parameters between the overlapped bounding boxes and the foreground image region, and the target detection accuracy is improved.

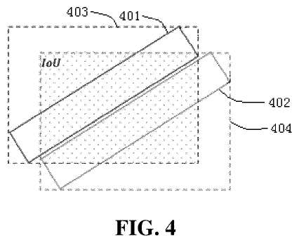

In the related art, since the usually used anchor box is a rectangular box without the angle parameter, for the target object having an excessive length-width ratio such as the vessel, when the target object is in a tilted state, the target bounding box determined by use of such an anchor box is a circumscribed rectangular box of the target object, and the area of the circumscribed rectangular box is greatly different from the true area of the target object. For two closely arranged target objects, as shown in FIG. 4, the target bounding box 403 corresponding to the target object 401 is the circumscribed rectangular box of the target object 401, and the target bounding box 404 corresponding to the target object 402 is also the circumscribed rectangular box of the target object 402. The overlapping parameter between the target bounding boxes of the two target objects is the IoU between the two circumscribed rectangular boxes. Due to the difference between the target bounding box and the target object in area, the calculated IoU has a very large error, and thus the recall of the target detection is reduced.

Hence, as mentioned above, in some embodiments, the angle parameter of the anchor box may be provided with the anchor box in the disclosure, thereby increasing the accuracy of calculation on the IoU. The angles of different target bounding boxes that are calculated by the anchor box may also vary from each other.

In view of this, the disclosure provides the following method for calculating the overlapping parameter: an angle factor is obtained based on the angle between the first bounding box and the second bounding box; and the overlapping parameter is obtained according to an IoU between the first bounding box and the second bounding box and the angle factor.

In an example, the overlapping parameter is a product of the IoU and the angle factor; and the angle factor may be obtained according to the angle between the first bounding box and the second bounding box. A value of the angle factor is smaller than 1, and increases with the increase of an angle between the first bounding box and the second bounding box.

For example, the angle factor may be represented by the formula (1):

$$γ = cos ( \frac{\frac{π}{2} - \vert θ \vert}{2} ) \qquad ( 1 )$$

Where, the θ is the angle between the first bounding box and the second bounding box.

In another example, in a case where the IoU keeps fixed, the overlapping parameter increases with the increase of the angle between the first bounding box and the second bounding box.

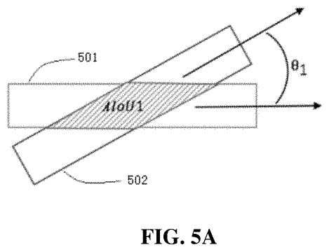

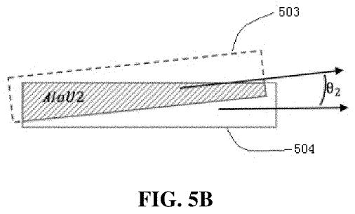

Hereinafter, FIG. 5A and FIG. 5B are used as an example to describe the influence of the above method for calculating the overlapping parameter on the target detection.

For the bounding box 501 and the bounding box 502 in FIG. 5A, the IoU of the areas of the two bounding boxes is AIoU1, and the angle between the two bounding boxes is θ₁. For the bounding box 503 and the bounding box 504 in FIG. 5B, the IoU of the areas of the two bounding boxes is AIoU2, and the angle between the two bounding boxes is θ₂. AIoU1<AIoU2.

An angle factor Y is added to calculate the overlapping parameter by using the above method for calculating the overlapping parameter. For example, the overlapping parameter is obtained by multiplying the IoU of the areas of the two bounding boxes and the angle factor.

For example, the overlapping parameter β1 between the bounding box 501 and the bounding box 502 may be calculated by using the formula (2):

$$β1 = AIoU 1 * cos ( \frac{\frac{π}{2} - \vert {θ}_{1} \vert}{2} ) \qquad ( 2 )$$

For example, the overlapping parameter β2 between the bounding box 503 and the bounding box 504 may be calculated by using the formula (3):

$$β2 = AIoU 2 * cos ( \frac{\frac{π}{2} - \vert {θ}_{2} \vert}{2} ) \qquad ( 3 )$$

With calculation, β1>β2 may be obtained.

After the angle factor is added, compared with the result calculated with the IoU of the areas, the calculation results of the overlapping parameters in FIG. 5A and FIG. 5B are the other way around. This is because the angle between the two bounding boxes in FIG. 5A is large, the value of the angle factor is also large and thus the obtained overlapping parameter becomes large. Correspondingly, the angle between the two bounding boxes in FIG. 5B is small, the value of the angle factor is also small and thus the obtained overlapping parameter becomes small.

For two closely arranged target objects, the angle therebetween may be very small. However, due to the close arrangement, it may be detected that the overlapped portion of the areas of the two bounding boxes may be large. If the IoU is only calculated with the areas, the result of the IoU may be large and thus it is prone to determine mistakenly that the two bounding boxes include the same target object. According to the method for calculating the overlapping parameter provided by the embodiments of the disclosure, with the introduction of the angle factor, the calculated result of the overlapping parameter between the closely arranged target objects becomes small, which is favorable to detect the target objects accurately and improve the recall of the closely arranged targets.

It is to be understood by those skilled in the art that the above method for calculating the overlapping parameter is not limited to the calculation of the overlapping parameter between the target bounding boxes, and may also be used to calculate the overlapping parameter between boxes having the angle parameter such as the candidate bounding box, the foreground anchor box, the ground-truth bounding box and the anchor box. Additionally, the overlapping parameter may also be calculated with other manners, which is not limited thereto in the embodiment of the disclosure.

In some examples, the above method for target detection may be implemented by a trained target detection network, and the target detection network may be a neutral network. The target detection network is trained first before use so as to obtain an optimized parameter value.

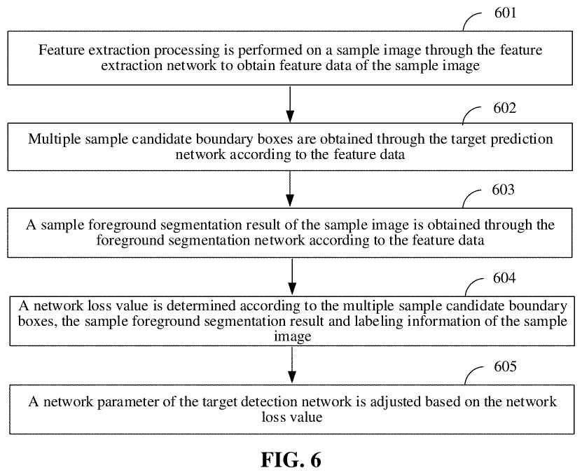

The vessel is still used as an example hereinafter to describe a training process of the target detection network. The target detection network may include a feature extraction network, a target prediction network and a foreground segmentation network. Referring to the flowchart of the embodiments of the training method illustrated in FIG. 6, the process may include the following operations.

In 601, feature extraction processing is performed on a sample image through the feature extraction network to obtain feature data of the sample image.

In this operation, the sample image may be a remote sensing image. The remote sensing image is an image obtained through a ground-object electromagnetic radiation feature signal detected by a sensor carried on an artificial satellite and an aerial plane. The sample image may also be other types of images and is not limited to the remote sensing image. In addition, the sample image includes labeling information of the preliminarily labeled target object. The labeling information may include a ground-truth bounding box of the labeled target object. In an example, the labeling information may be coordinates of four vertexes of the labeled ground-truth bounding box. The feature extraction network may be a convolutional neural network. The specific structure of the feature extraction network is not limited in the embodiments of the disclosure.

In 602, multiple sample candidate bounding boxes are obtained through the target prediction network according to the feature data.

In this operation, multiple candidate bounding boxes of the target object are predicted and generated according to the feature data of the sample image. The information included in the candidate bounding box may include at least one of the followings: probabilities that the inside of the bounding box is the foreground and the background, and a parameter of the bounding box such as a size, an angle, a position and the like of the bounding box.

In 603, a foreground segmentation result of the sample image is obtained according to the feature data.

In this operation, the sample foreground segmentation result of the sample image is obtained through the foreground segmentation network according to the feature data. The foreground segmentation result includes indication information for indicating whether each of multiple pixels of the input image belongs to a foreground. That is, the corresponding foreground image region may be obtained through the foreground segmentation result. The foreground image region includes all pixels predicted as the foreground.

In 604, a network loss value is determined according to the multiple sample candidate bounding boxes, the sample foreground segmentation result and labeling information of the sample image.

The network loss value may include a first network loss value corresponding to the target prediction network, and a second network loss value corresponding to the foreground segmentation network.

In some examples, the first network loss value is obtained according to the labeling information of the sample image and the information of the sample candidate bounding box. In an example, the labeling information of the target object may be coordinates of four vortexes of the ground-truth bounding box of the target object. The prediction parameter of the sample candidate bounding box obtained by prediction may be a length, a width, a rotation angle relative to a horizontal plane, and a coordinate of a central point, of the sample candidate bounding box. Based on the coordinates of the four vortexes of the ground-truth bounding box, the length, width, rotation angle relative to the horizontal plane and coordinate of the central point of the ground-truth bounding box may be calculated correspondingly. Therefore, based on the prediction parameter of the sample candidate bounding box and the true parameter of the ground-truth bounding box, the first network loss value that embodies a difference between the labeling information and the prediction information may be obtained.

In some examples, the second network loss value is obtained according to the sample foreground segmentation result and the true foreground image region. Based on the preliminarily labeled ground-truth bounding box of the target object, the original labeled region including the target object in the sample image may be obtained. The pixel included in the region is the true foreground pixel, and thus the region is the true foreground image region. Therefore, based on the sample foreground segmentation result and the labeling information, i.e., the comparison between the predicted foreground image region and the true foreground image region, the second network loss value may be obtained.

In 605, a network parameter of the target detection network is adjusted based on the network loss value.

In an example, the network parameter may be adjusted with a gradient back propagation method.

As the prediction of the candidate bounding box and the prediction of the foreground image region share the feature data extracted by the feature extraction network, by adjusting the parameter of each network jointly through differences between the prediction results of the two branches and the labeled true target object, the object-level supervision information and the pixel-level supervision information can be provided at the same time, and thus the quality of the feature extracted by the feature extraction network is improved. Meanwhile, the network for predicting the candidate bounding box and the foreground image in the embodiments of the disclosure is a one-stage detector, such that the relatively high detection efficiency can be implemented.

In an example, the first network loss value may be determined based on the IoUs between the multiple sample candidate bounding boxes and at least one ground-truth target bounding box labeled in the sample image.

In an example, a positive sample and/or a negative sample may be selected from multiple anchor boxes by using the calculated result of the IoUs. For example, the anchor box of which the IoU with the ground-truth bounding box is greater than a certain value such as 0.5 may be considered as the candidate bounding box including the foreground, and is used as the positive sample to train the target detection network. The anchor box of which the IoU with the ground-truth bounding box is smaller than a certain value such as 0.1 is used as the negative sample to train the network. The first network loss value is determined based on the selected positive sample and/or negative sample.

During the calculation of the first network loss value, due to the excessive length-width ratio of the target object, the IoU between the anchor box and the ground-truth bounding box that is calculated in the relevant art may be small, such that the number of selected positive samples for calculating the loss value becomes less, thereby affecting the training accuracy. In addition, the anchor box having the direction parameter is used in the embodiments of the disclosure. In order to adapt to the anchor box and improve the calculation accuracy of the IoU, the disclosure provides a method for calculating the IoU. The method may be used to calculate the IoU between the anchor box and the ground-truth, and may also be used to calculate the IoU between the candidate bounding box and the ground-truth bounding box.

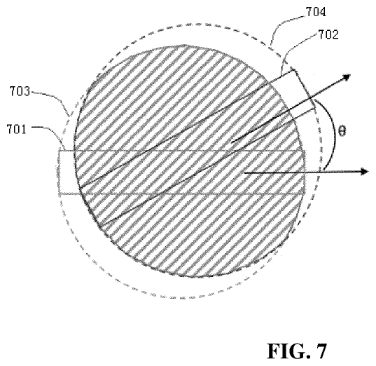

In the method, a ratio of an intersection to a union of the areas of the circumcircles of the anchor box and the ground-truth bounding box may be used as the IoU. Hereinafter, FIG. 7 is used as an example for description.

The bounding box 701 and the bounding box 702 are rectangular boxes having excessive length-width ratios and angle parameters, and for example, both have the length-width ratio of 5. The circumcircle of the bounding box 701 is the circumcircle 703 and the circumcircle of the bounding box 702 is the circumcircle 704. The ratio of the intersection (the shaded portion in the figure) to the union of the areas of the circumcircle 703 and the circumcircle 704 may be used as the IoU.

The IoU between the anchor box and the ground-truth bounding box may also be calculated in other manners, which is not limited thereto in the embodiments of the disclosure.

According to the method for calculating the IoU in the above embodiments, with restrictions on direction information, more samples which are similar in shape but different in direction are kept, such that the number and proportion of the selected positive samples are increased, thereby enhancing the supervision and learning on the direction information, and the prediction accuracy on direction is improved.

In the following description, the training method for target detection network will be described in more detail. Hereinafter, the case where the detected target object is the vessel is used as an example to describe the training method. It is to be understood that the detected target object in the disclosure is not limited to the vessel, and may also be other objects having the excessive length-width ratios.

A Sample is Prepared

Before the neutral network is trained, a sample set may be firstly prepared. The sample set may include: multiple training samples for training the target detection network.

For example, the training sample may be obtained as per the following manner.

On the remote sensing image, which is taken as the sample image, the ground-truth bounding box of the vessel is labeled. The remote sensing image may include multiple vessels, and it is necessary to label the ground-truth bounding box of each vessel. At the meantime, parameter information of each ground-truth bounding box, such as coordinates of four vortexes of the bounding box, needs to be labeled.

While the ground-truth bounding box of the vessel is labeled, the pixel in the ground-truth bounding box may be determined as a true foreground pixel, i.e., while the ground-truth bounding box of the vessel is labeled, a true foreground image of the vessel is obtained. It is to be understood by those skilled in the art that the pixel in the ground-truth bounding box also includes a pixel included by the ground-truth bounding box itself.

A Structure of the Target Detection Network is Determined

In an embodiment of the disclosure, the target detection network may include a feature extraction network, as well as a target prediction network and a foreground segmentation network that are cascaded to the feature extraction network respectively.

The feature extraction network is configured to extract the feature of the sample image, and may be the convolutional neural network. For example, existing Visual Geometry Group (VGG) network, ResNet, DenseNet and the like may be used, and structures of other convolutional neural networks may also be used. The specific structure of the feature extraction network is not limited in the disclosure. In an optional implementation mode, the feature extraction network may include a convolutional layer, an excitation layer, a pooling layer and other network units, and is formed by staking the above network units according to a certain manner.

The target prediction network is configured to predict the bounding box of the target object, i.e., prediction information for the candidate bounding box is predicted and generated. The specific structure of the target prediction network is not limited in the disclosure. In an optional implementation mode, the target prediction network may include a convolutional layer, a classification layer, a regression layer and other network units, and is formed by staking the above network units according to a certain manner.

The foreground segmentation network is configured to predict the foreground image in the sample image, i.e., predict the pixel region including the target object. The specific structure of the foreground segmentation network is not limited in the disclosure. In an optional implementation mode, the foreground segmentation network may include an upsampling layer and a mask layer, and is formed by staking the above network units according to a certain manner.

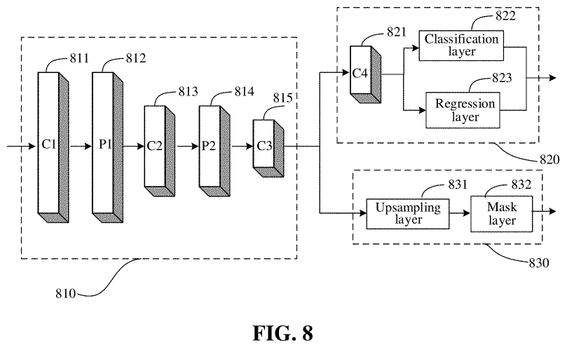

FIG. 8 illustrates a network structure of a target detection network to which the embodiments of the disclosure may be applied. It is to be noted that FIG. 8 only exemplarily illustrates the target detection network, and is not limited thereto in actual implementation.

As shown in FIG. 8, the target detection network includes a feature extraction network 810, as well as a target prediction network 820 and a foreground segmentation network 830 that are cascaded to the feature extraction network 810 respectively.

The feature extraction network 810 includes a first convolutional layer (C1) 811, a first pooling layer (P1) 812, a second convolutional layer (C2) 813, a second pooling layer (P2) 814 and a third convolutional layer (C3) 815 that are connected in sequence, i.e., in the feature extraction network 810, the convolutional layers and the pooling layers are connected together alternately. The convolutional layer may respectively extract different features in the image through multiple convolution kernels to obtain multiple feature maps. The pooling layer is located behind the convolutional layer, and may perform local averaging and downsampling operations on data of the feature map to reduce the resolution ratio of the feature data. With the increase of the number of convolutional layers and the pooling layers, the number of feature maps increases gradually, and the resolution ratio of the feature map decreases gradually.

Multi-channel feature data output by the feature extraction network 810 is respectively input to the target prediction network 820 and the foreground segmentation network 830.

The target prediction network 820 includes a fourth convolutional layer (C4) 821, a classification layer 822 and a regression layer 823. The classification layer 822 and the regression layer 823 are respectively cascaded to the fourth convolutional layer 821.

The fourth convolutional layer 821 performs convolution on the input feature data by use of a slide window (such as, 3*3), each window corresponds to multiple anchor boxes, and each window generates a vector for fully connecting to the regression layer 823 and the regression layer 824. Herein, two or more convolutional layers may further be used to perform the convolution on the input feature data.

The classification layer 822 is configured to determine whether the inside of a bounding box generated by the anchor box is a foreground or a background. The regression layer 823 is configured to obtain an approximate position of a candidate bounding box. Based on output results of the classification layer 822 and the regression layer 823, a candidate bounding box including a target object may be predicted, and a probabilities that the inside of the candidate bounding box is the foreground and the background, and a parameter of the candidate bounding box are output.

The foreground segmentation network 830 includes an upsampling layer 831 and a mask layer 832. The upsampling layer 831 is configured to convert the input feature data into an original size of the sample image; and the mask layer 832 is configured to generate a binary mask of the foreground, i.e., 1 is output for a foreground pixel, and 0 is output for a background pixel.

In addition, when the overlapping area between the candidate bounding box and the foreground image region is calculated, the size of the image may be converted by the fourth convolutional layer 821 and the mask layer 832, so that the feature positions are corresponding. That is, the outputs of the target prediction network 820 and the foreground segmentation network 830 may be used to predict the information at the same position on the image, thus calculating the overlapping area.

Before the target detection network is trained, some network parameters may be set, for example, the numbers of convolution kernels used in each convolutional layer of the feature extraction network 810 and in the convolutional layer of the target prediction network may be set, the sizes of the convolution kernels may further be set, etc. Parameter values such as a value of the convolution kernel and a weight of other layers may be self-learned through iterative training.

Upon that the training sample is prepared and the structure of the target detection network is initialized, the training for the target detection network may be started. The specific training method for the target detection network will be listed below.

First Training Method for the Target Detection Network

In some embodiments, the structure of the target detection network may refer to FIG. 8.

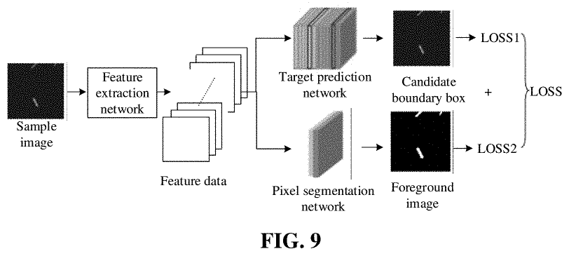

Referring to the example in FIG. 9, the sample image input to the target detection network may be a remote sensing image including a vessel image. On the sample image, the ground-truth bounding box of the included vessel is labeled, and the labeling information may be parameter information of the ground-truth bounding box, such as coordinates of four vortexes of the bounding box.

The input sample image is firstly subjected to the feature extraction network to extract the feature of the sample image, and the multi-channel feature data of the sample image is output. The size and the number of channels of the output feature data are determined by the convolutional layer structure and the pooling layer structure of the feature extraction network.

The multi-channel feature data enters the target prediction network on one hand. The target prediction network predicts a candidate bounding box including the vessel based on the current network parameter setting and the input feature data, and generates prediction information of the candidate bounding box. The prediction information may include probabilities that the bounding box is the foreground and the background, and parameter information of the bounding box such as a size, a position, an angle and the like of the bounding box. Based on the labeling information of the preliminarily labeled target object and the prediction information of the predicted candidate bounding box, a value LOSS1 of a first network loss function, i.e., the first network loss value, may be obtained. The value of the first network loss function embodies a difference between the labeling information and the prediction information.

On the other hand, the multi-channel feature data enters the foreground segmentation network. The foreground segmentation network predicts, based on the current network parameter setting, the foreground image region, including the vessel, in the sample image. For example, through the probabilities that each pixel in the feature data is the foreground and the background, by using the pixels, each of which the probability of the pixel being the foreground is greater than the set value, as the foreground pixels, the pixel segmentation are performed, thereby obtaining the predicted foreground image region.

As the ground-truth bounding box of the vessel is preliminarily labeled in the sample image, with the parameters of the ground-truth bounding box such as the coordinates of the four vortexes, the foreground pixel in the sample image may be obtained, i.e., the true foreground image in the sample image is obtained. Based on the predicted foreground image, and the true foreground image obtained by the labeling information, a value LOSS2 of a second network loss function, i.e., the second network loss value, may be obtained. The value of the second network loss function embodies a difference between the predicted foreground image and the labeling information.

A total loss value jointly determined based on the value of the first network loss function and the value of the second network loss function may be reversely transmitted back to the target detection network, to adjust the value of the network parameter. For example, the value of the convolution kernel and the weight of other layers are adjusted. In an example, the sum of the first network loss function and the second network loss function may be determined as a total loss function, and the parameter is adjusted by using the total loss function.

When the target detection network is trained, the training sample set may be divided into multiple image batches, and each image batch includes one or more training samples. During iterative training each time, one image batch is sequentially input to the network; and the network parameter is adjusted in combination with a loss value of each sample prediction result in the training sample included in the image batch. Upon the completion of the current iterative training, a next image batch is input to the network for next iterative training. Training samples included in different image batches are at least partially different. When a predetermined end condition is reached, the training of the target detection network may be completed. The predetermined end condition may, for example, be that the total loss value is reduced to a certain threshold, or the predetermined number of iterative times of the target detection network is reached.

According to the training method for target detection network in the embodiment, the target prediction network provides the object-level supervision information, and the pixel segmentation network provides the pixel-level supervision information. By means of the two different levels of supervision information, the quality of the feature extracted by the feature extraction network is improved; and with the one-stage target prediction network and the pixel segmentation network for detection, the detection efficiency is improved.

Second Training Method for the Target Detection Network

In some embodiments, the target prediction network may predict the candidate bounding box of the target object in the following manner. The structure of the target prediction network may refer to FIG. 8.

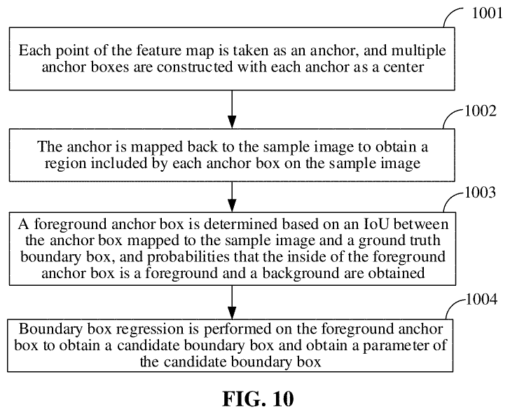

FIG. 10 is a flowchart of a method for predicting a candidate bounding box. As shown in FIG. 10, the flow may include the following operations.

In 1001, each point of the feature data is taken as an anchor, and multiple anchor boxes are constructed with each anchor as a center.

For example, for a feature layer having the size of [H*W], H*W*k anchor boxes are constructed in total, where, the k is the number of anchor boxes generated by each anchor. Different length-width ratios are provided for the multiple anchor boxes constructed at one anchor, so as to cover a to-be-detected target object. Firstly, a priori anchor box may be directly generated through hyper-parameter setting based on priori knowledge, such as a statistic on a size distribution of most targets, and then the anchor boxes are predicted through a feature.

In 1002, the anchor is mapped back to the sample image to obtain a region included by each anchor box on the sample image.

In this operation, all anchors are mapped back to the sample image, i.e., the feature data is mapped to the sample image, such that regions included by the anchor boxes, generated with the anchors as the centers, in the sample image are obtained. The positions and the sizes that the anchor boxes mapped to the sample image may be calculated jointly through the priori anchor box and the prediction value and in combination with the current feature resolution ratio, to obtain the region included by each anchor box on the sample image.

The above process is equivalent to use a convolution kernel (slide window) to perform a slide operation on the input feature data. When the convolution kernel slides to a certain position of the feature data, the center of the current slide window is used as a center to map back to a region of the sample image; and the center of the region on the sample image is the corresponding anchor; and then, the anchor box is framed with the anchor as the center. That is, although the anchor is defined based on the feature data, it is relative to the original sample image finally.

For the structure of the target prediction network shown in FIG. 8, the feature extraction process may be implemented through the fourth convolutional layer 821, and the convolution kernel of the fourth convolutional layer 821 may, for example, have a size of 3*3.

In 1003, a foreground anchor box is determined based on an IoU between the anchor box mapped to the sample image and a ground-truth bounding box, and probabilities that the inside of the foreground anchor box is a foreground and a background are obtained.

In this operation, which anchor box that the inside is the foreground, and which anchor that the inside is the background are determined by comparing the overlapping condition between the region included by the anchor box on the sample image and the ground-truth bounding box. That is, the label indicating the foreground or the background is provided for each anchor box. The anchor box having the foreground label is the foreground anchor box, and the anchor box having the background label is the background anchor box.

In an example, the anchor box of which the IoU with the ground-truth bounding box is greater than a first set value such as 0.5 may be viewed as the candidate bounding box containing the foreground. Moreover, binary classification may further be performed on the anchor box to determine the probabilities that the inside of the anchor box is the foreground and the background.

The foreground anchor box may be used to train the target detection network. For example, the foreground anchor box is used as the positive sample to train the network, such that the foreground anchor box is participated in the calculation of the loss function. Meanwhile, such a part of loss is often referred as the classification loss, and is obtained by comparing with the label of the foreground anchor box based on the binary classification probability of the foreground anchor box.

One image batch may include multiple anchor boxes, having foreground labels, randomly extracted from one sample image. The multiple (such as 256) anchor boxes may be taken as the positive samples for training.

In an example, in a case where the number of positive samples is insufficient, the negative sample may further be used to train the target detection network. The negative sample may, for example, be the anchor box of which the IoU with the ground-truth bounding box is smaller than a second set value such as 0.1.

In the example, one image batch may include 256 anchor boxes randomly extracted from the sample image, in which 128 anchor boxes having the foreground labels and are served as the positive samples, and another 128 labels are the anchor boxes of which the IoU with the ground-truth bounding box is smaller than the second set value such as 0.1, and are served as the negative samples. Therefore, the proportion of the positive samples to the negative samples reaches 1:1. If the number of positive samples in one image is smaller than 128, more negative samples may be used to meet the 256 anchor boxes for training.

In 1004, bounding box regression is performed on the foreground anchor box to obtain a candidate bounding box and obtain a parameter of the candidate bounding box.

In this operation, the parameter type of each of the foreground anchor box and the candidate bounding box is consistent with that of the anchor box, i.e., the parameter(s) included in the constructed anchor box is/are also included in the generated candidate bounding box.

The foreground anchor box obtained in operation 1003 may be different from the vessel in the sample image in length-width ratio, and the position and angle of the foreground anchor box may also be different from those of the sample vessel, so it is necessary to use the offsets between the foreground anchor box and the corresponding ground-truth bounding box for regressive training. Thus, the target prediction network has the capability of predicting the offsets from it to the candidate bounding box through the foreground bounding box, thereby obtaining the parameter of the candidate bounding box.

Through operation 1003 and operation 1004, the information of the candidate bounding box: the probabilities that the inside of the candidate bounding box is the foreground and the background, and the parameter of the candidate bounding box, may be obtained. Based on the above information of the candidate bounding box and the labeling information in the sample image (the ground-truth bounding box corresponding to the target object), the first network loss may be obtained.

In the embodiments of the disclosure, the target prediction network is the one-stage network; and after the candidate bounding box is predicted for a first time, a prediction result of the candidate bounding box is output. Therefore, the detection efficiency of the network is improved.

Third Training Method for the Target Detection Network

In the relevant art, the parameter of the anchor box corresponding to each anchor generally includes a length, a width and a coordinate of a central point. In the example, a method for setting a rotary anchor box is provided.

In an example, anchor boxes in multiple directions may be constructed with each anchor as a center, and multiple length-width ratios may be set to cover the to-be-detected target object. The specific number of directions and the specific values of the length-width ratios may be set according to an actual demand. As shown in FIG. 11, the constructed anchor box corresponds to six directions, where, the w denotes a width of the anchor box, the 1 denotes a length of the anchor box, the 0 denotes an angle of the anchor box (a rotation angle of the anchor box relative to a horizontal direction), and the (x,y) denotes a coordinate of a central point of the anchor box. For the six anchor boxes uniformly distributed corresponding to the direction, the θ is 0°, 30°, 60°, 90°, −30° and −60° respectively. Correspondingly, in the example, the parameter of the anchor box may be represented as (x,y,w,l,θ). The length-width ratio may be set as 1, 3, 5, and may also be set as other values for the detected target object.

In some embodiments, the parameter of the candidate bounding box may also be represented as (x,y,w,l,θ). The parameter may be subjected to regressive calculation by using the regression layer 823 in FIG. 8. The regressive calculation method is as follows.

Firstly, offsets from a foreground anchor box to a ground-truth bounding box are calculated.

For example, the parameter values of the foreground anchor box are [Aₓ,A_{y},A_{w},Aₗ,A_{θ}], where, the Aₓ, the A_{y}, the A_{w}, the Aₗ, and the A_{θ} respectively denote a coordinate of a central point x, a coordinate of a central point y, a width, a length and an angle of the foreground anchor box; and the corresponding five values of the ground-truth bounding box are [Gₓ,G_{y},G_{w},Gₗ,G_{θ}], where, the Gₓ, the G_{y}, the G_{w}, the Gₗ and the G_{θ} respectively denote a coordinate of a central point x, a coordinate of a central point y, a width, a length and an angle, of the ground-truth bounding box.

The offsets [dₓ(A), d_{y}(A), d_{w}(A), dₗ(A), d_{θ}(A)] between the foreground anchor box and the ground-truth bounding box may be determined based on the parameter values of the foreground anchor box and the values of the ground-truth bounding box, where, the dx(A), the dy(A), the dw(A), the dl(A) and the dθ(A) respectively denote offsets for the coordinate of the central point x, coordinate of the central point y, width, length and angle. Each offset may be calculated through formulas (4)-(8):

dₓ(A)=(Gₓ−Aₓ)/A_{w} (4)

d_{y}(A)=(G_{y}−A_{y})/Aₗ (5)

d_{w}(A)=log(G_{w}/A_{w}) (6)

dₗ(A)=log(Gₗ/Aₗ) (7)

d_{θ}(A)=G_{θ}−A_{θ} (8)

The formula (6) and the formula (7) use a logarithm to denote the offsets of the length and width, so as to obtain rapid convergence in case of a large difference.

In an example, in a case where the input multi-channel feature data has multiple ground-truth bounding boxes, each foreground anchor box selects a ground-truth bounding box having the highest degree of overlapping to calculate the offsets.

Then, offsets from the foreground anchor box to a candidate bounding box are obtained.

Herein, in order to search an expression to establish the relationship between the anchor box and the ground-truth bounding box, the regression may be used. With the network structure in FIG. 8 as an example, the regression layer 823 may be trained with the above offsets. Upon the completion of the training, the target prediction network has the ability of identifying the offsets [dₓ′(A), d_{y}′(A), d_{w}′(A), dₗ′(A), d_{θ}′(A)] from each anchor box to the corresponding optical candidate bounding box, i.e., the parameter values of the candidate bounding box, including the coordinate of the central x, coordinate of the central point y, width, length and angle, may be determined according to the parameter value of the anchor box. During training, the offsets from the foreground anchor box to the candidate bounding box may be calculated firstly by using the regression layer. Since the network parameter is not optimized completely in training, the offsets may be greatly different from the actual offsets [dₓ(A), d_{y}(A), d_{w}(A), dₗ(A), d_{θ}(A)].

At last, the foreground anchor box is shifted based on the offsets to obtain the candidate bounding box and obtain the parameter of the candidate bounding box.

When the value of the first network loss function is calculated, the offsets [dₓ′(A), d_{y}′(A), d_{w}′(A), dₗ′(A), d_{θ}′(A)] from the foreground anchor box to the candidate bounding box and the offsets [dₓ(A), d_{y}(A), d_{w}(A), dₗ(A), d_{θ}(A)] from the foreground anchor box to the ground-truth bounding box during training may be used to calculate a regression loss.

The above predicted probabilities that the inside of the foreground anchor box is the foreground and the background are the probabilities that the inside of the candidate bounding box is the foreground and the background, after the foreground anchor box is subjected to the regression to obtain the candidate bounding box. Based on the probabilities, the classification losses that the inside of the predicted candidate bounding box is the foreground and the background may be determined. The sum of the classification loss and the regression loss of the parameter of the predicted candidate bounding box forms the value of the first network loss function. For one image batch, the network parameter may be adjusted based on the values of the first network loss functions of all candidate bounding boxes.

By providing the anchor boxes with the directions, the circumscribed rectangular bounding boxes more suitable for the posture of the target object may be generated, such that the overlapping portion between the bounding boxes is calculated more strictly and accurately.

Fourth Training Method for the Target Detection Network

When the value of the first network loss function is obtained based on the standard information and the information of the candidate bounding box, a weight proportion of each parameter of the anchor box may be set, such that the weight proportion of the width is higher than that of each of other parameters; and according to the set weight proportions, the value of the first network loss function is calculated.

The higher the weight proportion of the parameter, the larger the contribution to the finally calculated loss function value. When the network parameter is adjusted, more importance is attached to the influence of the adjustment effect on the parameter value, such that the calculation accuracy of the parameter is higher than other parameters. For the target object having the excessive length-width ratio, such as the vessel, the width is much smaller relative to the length. Hence, by setting the weight of the width to be higher than that of each of other parameters, the prediction accuracy on the width may be improved.

Fifth Training Method for the Target Detection Network

In some embodiments, the foreground image region in the sample image may be predicted in the following manner. The structure of the foreground segmentation network may refer to FIG. 8.

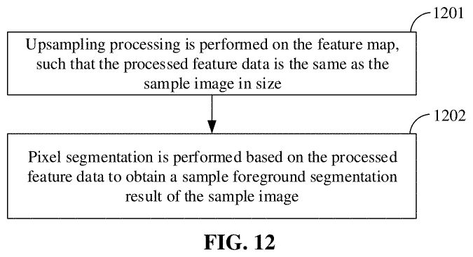

FIG. 12 is a flowchart of an embodiment of a method for predicting a foreground image region. As shown in FIG. 12, the flow may include the following operations.

In 1201, upsampling processing is performed on the feature data, so as to make a size of the processed feature data to be same as that of the sample image.

For example, the upsampling processing may be performed on the feature data through a deconvolutional layer or a bilinear difference, and the feature data is amplified to the size of the sample image. Since the multi-channel feature data is input to the pixel segmentation network, the feature data having the corresponding number of channels and consistent size with the sample image is obtained after the upsampling processing. Each position of the feature data is in one-to-one correspondence with the position on the original image.

In 1202, pixel segmentation is performed based on the processed feature data to obtain a sample foreground segmentation result of the sample image.

For each pixel of the feature data, the probabilities that the pixel belongs to the foreground and the background may be determined. A threshold may be set. The pixel, of which the probability of the pixel being the foreground is greater than the set threshold, is determined as the foreground pixel. Mask information can be generated for each pixel, and may be expressed as 0, 1 generally, where 0 denotes the background, and 1 denotes the foreground. Based on the mask information, the pixel that is the foreground may be determined, and thus a pixel-level foreground segmentation result is obtained. As each pixel of the feature data corresponds to the region on the sample image, and the ground-truth bounding box of the target object is labeled in the sample image, a difference between the classification result of each pixel and the ground-truth bounding box is determined according to the labeling information to obtain the classification loss.

The pixel segmentation network does not involve in the position determination of the bounding box, the corresponding value of the second network loss function may be determined through a sum of the classification loss of each pixel. By continuously adjusting the network parameter, the second network loss value is minimized, such that the classification of each pixel is more accurate, and the foreground image of the target object is determined more accurately.

In some embodiments, by performing the upsampling processing on the feature data, and generating the mask information for each pixel, the pixel-level foreground image region may be obtained, and the accuracy of the target detection is improved.

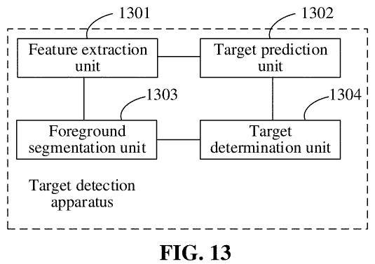

FIG. 13 provides an apparatus for target detection. As shown in FIG. 13, the apparatus may include: a feature extraction unit 1301, a target prediction unit 1302, a foreground segmentation unit 1303 and a target determination unit 1304.

The feature extraction unit 1301 is configured to obtain feature data of an input image.

The target prediction unit 1302 is configured to determine multiple candidate bounding boxes of the input image according to the feature data.

The foreground segmentation unit 1303 is configured to obtain a foreground segmentation result of the input image according to the feature data, the foreground segmentation result including indication information for indicating whether each of multiple pixels of the input image belongs to a foreground.

The target determination unit 1304 is configured to obtain a target detection result of the input image according to the multiple candidate bounding boxes and the foreground segmentation result.

In another embodiment, the target determination unit 1304 is specifically configured to: select at least one target bounding box from the multiple candidate bounding boxes according to an overlapping area between each candidate bounding box in the multiple candidate bounding boxes and a foreground image region corresponding to the foreground segmentation result; and obtain the target detection result of the input image based on the at least one target bounding box.

In another embodiment, when selecting the at least one target bounding box from the multiple candidate bounding boxes according to the overlapping area between each candidate bounding box in the multiple candidate bounding boxes and the foreground image region corresponding to the foreground segmentation result, the target determination unit 1304 is specifically configured to: take, for each candidate bounding box in the multiple candidate bounding boxes, if a ratio of an overlapping area between the candidate bounding box and the corresponding region to an area of the candidate bound is greater than a first threshold, the candidate bounding box as the target bounding box.

In another embodiment, the at least one target bounding box includes a first bounding box and a second bounding box, and when obtaining the target detection result of the input image based on the at least one target bounding box, the target determination unit 1304 is specifically configured to: determine an overlapping parameter between the first bounding box and the second bounding box based on an angle between the first bounding box and the second bounding box; and determine a target object position corresponding to the first bounding box and the second bounding box based on the overlapping parameter between the first bounding box and the second bounding box.

In another embodiment, when determining the overlapping parameter between the first bounding box and the second bounding box based on the angle between the first bounding box and the second bounding box, the target determination unit 1304 is specifically configured to: obtain an angle factor according to the angle between the first bounding box and the second bounding box; and obtain the overlapping parameter according to an IoU between the first bounding box and the second bounding box and the angle factor.

In another embodiment, the overlapping parameter between the first bounding box and the second bounding box is a product of the IoU and the angle factor; and the angle factor increases with an increase of the angle between the first bounding box and the second bounding box.

In another embodiment, in a case where the IoU keeps fixed, the overlapping parameter between the first bounding box and the second bounding box increases with the increase of the angle between the first bounding box and the second bounding box.

In another embodiment, the operation that the target object position corresponding to the first bounding box and the second bounding box is determined based on the overlapping parameter between the first bounding box and the second bounding box includes that: in a case where the overlapping parameter between the first bounding box and the second bounding box is greater than a second threshold, one of the first bounding box and the second bounding box is taken as the target object position.

In another embodiment, the operation that the one of the first bounding box and the second bounding box is taken as the target object position includes that: an overlapping parameter between the first bounding box and the foreground image region corresponding to the foreground segmentation result is determined, and an overlapping parameter between the second bounding box and the foreground image region is determined; and one of the first bounding box and the second bounding box, of which the overlapping parameter with the foreground image region is larger than that of another, is taken as the target object position.

In another embodiment, the operation that the target object position corresponding to the first bounding box and the second bounding box is determined based on the overlapping parameter between the first bounding box and the second bounding box includes that: in a case where the overlapping parameter between the first bounding box and the second bounding box is smaller than or equal to the second threshold, each of the first bounding box and the second bounding box is taken as a target object position.

In another embodiment, a length-width ratio of a to-be-detected target object in the input image is greater than a specific value.

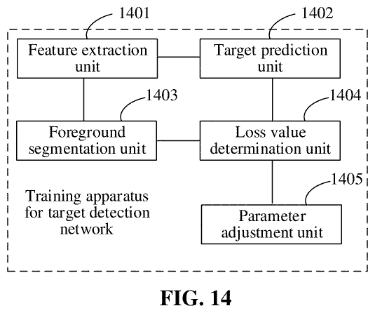

FIG. 14 provides a training apparatus for a target detection network. The target detection network includes a feature extraction network, a target prediction network and a foreground segmentation network. As shown in FIG. 14, the apparatus may include: a feature extraction unit 1401, a target prediction unit 1402, a foreground segmentation unit 1403, a loss value determination unit 1404 and a parameter adjustment unit 1405.

The feature extraction unit 1401 is configured to perform feature extraction processing on a sample image through the feature extraction network to obtain feature data of the sample image.

The target prediction unit 1402 is configured to obtain, according to the feature data, multiple sample candidate bounding boxes through the target prediction network.

The foreground segmentation unit 1403 is configured to obtain, according to the feature data, a sample foreground segmentation result of the sample image through the foreground segmentation network, the sample foreground segmentation result including indication information for indicating whether each of multiple pixels of the sample image belongs to a foreground.

The loss value determination unit 1404 is configured to determine a network loss value according to the multiple sample candidate bounding boxes, the sample foreground segmentation result and labeling information of the sample image.

The parameter adjustment unit 1405 is configured to adjust a network parameter of the target detection network based on the network loss value.

In another embodiment, the labeling information includes at least one ground-truth bounding box of at least one target object included in the sample image, and the loss value determination unit 1404 is specifically configured to: determine, for each candidate bounding box in the multiple candidate bounding boxes, an IoU between the candidate bounding box and each of at least one ground-truth bounding box labeled in the sample image; and determine a first network loss value according to the determined IoU for each candidate bounding box in the multiple candidate bounding boxes.

In another embodiment, the IoU between the candidate bounding box and the ground-truth bounding box is obtained based on a circumcircle including the candidate bounding box and the ground-truth bounding box.

In another embodiment, in a process of determining the network loss value, a weight corresponding to a width of the candidate bounding box is higher than a weight corresponding to a length of the candidate bounding box.

In another embodiment, the foreground segmentation unit 1403 is specifically configured to: perform upsampling processing on the feature data, so as to make a size of the processed feature data to be same as that of the sample image; and perform pixel segmentation based on the processed feature data to obtain the sample foreground segmentation result of the sample image.

In another embodiment, a length-width ratio of a target object included in the sample image is greater than a set value.

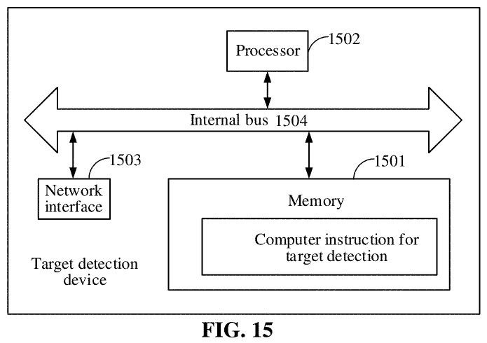

FIG. 15 is a device for target detection provided by at least one embodiment of the disclosure. The device includes a memory 1501 and a processor 1502; the memory is configured to store computer instructions capable of running on the processor; and the processor is configured to execute the computer instructions to implement the method for target detection in any embodiment of the description. The device may further include a network interface 1503 and an internal bus 1504. The memory 1501, the processor 1502 and the network interface 1503 communicate with each other through the internal bus 1504.

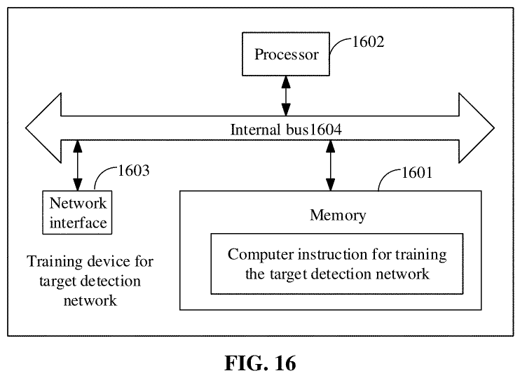

FIG. 16 is a training device for target detection network provided by at least one embodiment of the disclosure. The device includes a memory 1601 and a processor 1602; the memory is configured to store computer instructions capable of running on the processor; and the processor is configured to execute the computer instructions to implement the target detection network training method in any embodiment of the description. The device may further include a network interface 1603 and an internal bus 1604. The memory 1601, the processor 1602 and the network interface 1603 communicate with each other through the internal bus 1604.

At least one embodiment of the disclosure further provides a non-volatile computer-readable storage medium, which stores computer programs thereon; and the programs are executed by a processor to implement the method for target detection in any embodiment of the description, and/or, to implement raining method for the target detection network in any embodiment of the description.

In the embodiment of the disclosure, the computer-readable storage medium may be in various forms, for example, in different examples, the computer-readable storage medium may be: a non-volatile memory, a flash memory, a storage driver (such as a hard disk drive), a solid state disk, any type of memory disk (such as an optical disc and a Digital Video Disk (DVD)), or a similar storage medium, or a combination thereof. Particularly, the computer-readable medium may even be paper or another suitable medium upon which the program is printed. By use of the medium, the program can be electronically captured (such as optical scanning), and then compiled, interpreted and processed in a suitable manner, and then stored in a computer medium.

The above are merely preferred embodiments of the disclosure and are not intended to limit the disclosure. Any modification, equivalent replacement, improvement and the like made within the spirit and principle of the disclosure should be included in the scope of protection of the disclosure.

1. A method for target detection, comprising:
obtaining feature data of an input image;
determining multiple candidate bounding boxes of the input image according to the feature data;
obtaining a foreground segmentation result of the input image according to the feature data, the foreground segmentation result comprising indication information for indicating whether each of multiple pixels of the input image belongs to a foreground; and
obtaining a target detection result of the input image according to the multiple candidate bounding boxes and the foreground segmentation result.

2. The method of claim 1, wherein obtaining the target detection result of the input image according to the multiple candidate bounding boxes and the foreground segmentation result comprises:
selecting at least one target bounding box from the multiple candidate bounding boxes according to an overlapping area between each candidate bounding box in the multiple candidate bounding boxes and a foreground image region corresponding to the foreground segmentation result; and
obtaining the target detection result of the input image based on the at least one target bounding box.

3. The method of claim 2, wherein selecting the at least one target bounding box from the multiple candidate bounding boxes according to the overlapping area between each candidate bounding box in the multiple candidate bounding boxes and the foreground image region corresponding to the foreground segmentation result comprises:
for each candidate bounding box in the multiple candidate bounding boxes, if a ratio of an overlapping area between the candidate bounding box and the foreground image region to an area of the candidate bounding box is greater than a first threshold, taking the candidate bounding box as the target bounding box.

4. The method of claim 2, wherein the at least one target bounding box comprises a first bounding box and a second bounding box, and obtaining the target detection result of the input image based on the at least one target bounding box comprises:
determining an overlapping parameter between the first bounding box and the second bounding box based on an angle between the first bounding box and the second bounding box; and
determining a target object position corresponding to the first bounding box and the second bounding box based on the overlapping parameter between the first bounding box and the second bounding box.

5. The method of claim 4, wherein determining the overlapping parameter between the first bounding box and the second bounding box based on the angle between the first bounding box and the second bounding box comprises:
obtaining an angle factor according to the angle between the first bounding box and the second bounding box; and
obtaining the overlapping parameter according to an Intersection over Union (IoU) between the first bounding box and the second bounding box and to the angle factor.

6. The method of claim 5, wherein the overlapping parameter between the first bounding box and the second bounding box is a product of the IoU and the angle factor; and the angle factor increases with an increase of the angle between the first bounding box and the second bounding box.

7. The method of claim 5, wherein in a case where the IoU keeps fixed, the overlapping parameter between the first bounding box and the second bounding box increases with the increase of the angle between the first bounding box and the second bounding box.

8. The method of claim 4, wherein determining the target object position corresponding to the first bounding box and the second bounding box based on the overlapping parameter between the first bounding box and the second bounding box comprises:
in a case where the overlapping parameter between the first bounding box and the second bounding box is greater than a second threshold, taking one of the first bounding box and the second bounding box as the target object position.

9. The method of claim 8, wherein taking the one of the first bounding box and the second bounding box as the target object position comprises:
determining an overlapping parameter between the first bounding box and the foreground image region corresponding to the foreground segmentation result, and determining an overlapping parameter between the second bounding box and the foreground image region; and
taking one of the first bounding box and the second bounding box, of which the overlapping parameter with the foreground image region is larger than that of another, as the target object position.

10. The method of claim 4, wherein determining the target object position corresponding to the first bounding box and the second bounding box based on the overlapping parameter between the first bounding box and the second bounding box comprises:
in a case where the overlapping parameter between the first bounding box and the second bounding box is smaller than or equal to a second threshold, taking each of the first bounding box and the second bounding box as a target object position.

11. The method of claim 1, wherein a length-width ratio of a to-be-detected target object in the input image is greater than a specific value.

12. A training method for a target detection network, wherein the target detection network comprises a feature extraction network, a target prediction network and a foreground segmentation network, and the method comprises:
performing feature extraction processing on a sample image through the feature extraction network to obtain feature data of the sample image;
obtaining, according to the feature data, multiple sample candidate bounding boxes through the target prediction network;
obtaining, according to the feature data, a sample foreground segmentation result of the sample image through the foreground segmentation network, the sample foreground segmentation result comprising indication information for indicating whether each of multiple pixels of the sample image belongs to a foreground;
determining a network loss value according to the multiple sample candidate bounding boxes, the sample foreground segmentation result and labeling information of the sample image; and
adjusting a network parameter of the target detection network based on the network loss value.

13. An apparatus for target detection, comprising:
a memory and a processor, wherein the memory is configured to store computer instructions capable of running on the processor, and the processor is configured to:
obtain feature data of an input image;
determine multiple candidate bounding boxes of the input image according to the feature data;
obtain a foreground segmentation result of the input image according to the feature data, the foreground segmentation result comprising indication information for indicating whether each of multiple pixels of the input image belongs to a foreground; and
a obtain a target detection result of the input image according to the multiple candidate bounding boxes and the foreground segmentation result.

14. The apparatus of claim 13, wherein the processor is specifically configured to:
select at least one target bounding box from the multiple candidate bounding boxes according to an overlapping area between each candidate bounding box in the multiple candidate bounding boxes and a foreground image region corresponding to the foreground segmentation result; and
obtain the target detection result of the input image based on the at least one target bounding box.

15. The apparatus of claim 14, wherein when selecting the at least one target bounding box from the multiple candidate bounding boxes according to the overlapping area between each candidate bounding box in the multiple candidate bounding boxes and the foreground image region corresponding to the foreground segmentation result, the processor is specifically configured to:
take, for each candidate bounding box in the multiple candidate bounding boxes, if a ratio of an overlapping area between the candidate bounding box and the foreground image region to an area of the candidate bounding box is greater than a first threshold, the candidate bounding box as the target bounding box.

16. The apparatus of claim 14, wherein the at least one target bounding box comprises a first bounding box and a second bounding box, and when obtaining the target detection result of the input image based on the at least one target bounding box, the processor is specifically configured to:
determine an overlapping parameter between the first bounding box and the second bounding box based on an angle between the first bounding box and the second bounding box; and
determine a target object position corresponding to the first bounding box and the second bounding box based on the overlapping parameter between the first bounding box and the second bounding box.

17. The apparatus of claim 16, wherein when determining the overlapping parameter of the first bounding box and the second bounding box based on the angle between the first bounding box and the second bounding box, the processor is specifically configured to:
obtain an angle factor according to the angle between the first bounding box and the second bounding box; and
obtain the overlapping parameter according to an Intersection over Union (IoU) between the first bounding box and the second bounding box and the angle factor.

18. The apparatus of claim 17, wherein the overlapping parameter between the first bounding box and the second bounding box is a product of the IoU and the angle factor; and the angle factor increases with an increase of the angle between the first bounding box and the second bounding box.

19. The apparatus of claim 17, wherein in a case where the IoU keeps fixed, the overlapping parameter between the first bounding box and the second bounding box increases with the increase of the angle between the first bounding box and the second bounding box.

20. A non-transitory computer-readable storage medium, storing computer programs thereon, wherein the computer programs are executed by a processor to cause the processor to implement the method of claim 1.
